(19) United States
(12) Patent Application Publication
(10) Pub. No.: US 2005/0026576 A1
(43) Pub. Date: Feb. 3, 2005

(54) Transmitting and receiving arrangement with at least two pairs of respectively one transmitting power amplifier and one low noise input amplifier

(75) Inventors: Matthias Bopp, Langenbrettach (DE); Stephan Gerlach, Flein (DE)

Correspondence Address: FASSE PATENT ATTORNEYS, P.A., P.O. BOX 726, HAMPDEN, ME, 04444-0726, US

(73) Assignee: ATMEL Germany GmbH, Heilbronn (DE)

(21) Appl. No.: 10/903,723

(22) Filed: Jul. 30, 2004

(30) Foreign Application Priority Data
Aug. 1, 2003 (DE) 103 36 292.4

(51) Int. Cl. H04B 1/10

(52) U.S. Cl. 455/127.3; 455/127.1

(57) ABSTRACT

A transmitting and receiving arrangement for operation in any selected one of plural frequency ranges includes at least one transmitting power amplifier and at least one low noise input amplifier allocated respectively to each frequency range. The arrangement includes plural chips, that each include at least one input amplifier and at least one transmitting amplifier incorporated therein, e.g. in an integrated circuit. The input amplifier and the transmitting amplifier allocated to a particular frequency range are located on different chips. The input amplifier and the transmitting amplifier incorporated in one chip are allocated to different frequency ranges. In a communication in a given frequency range, the transmission amplification is handled through one chip and the input amplification is handled through a different chip. The dissipated heat from the transmitting amplifier does not directly heat and deteriorate the performance of the input amplifier allocated to the active frequency.

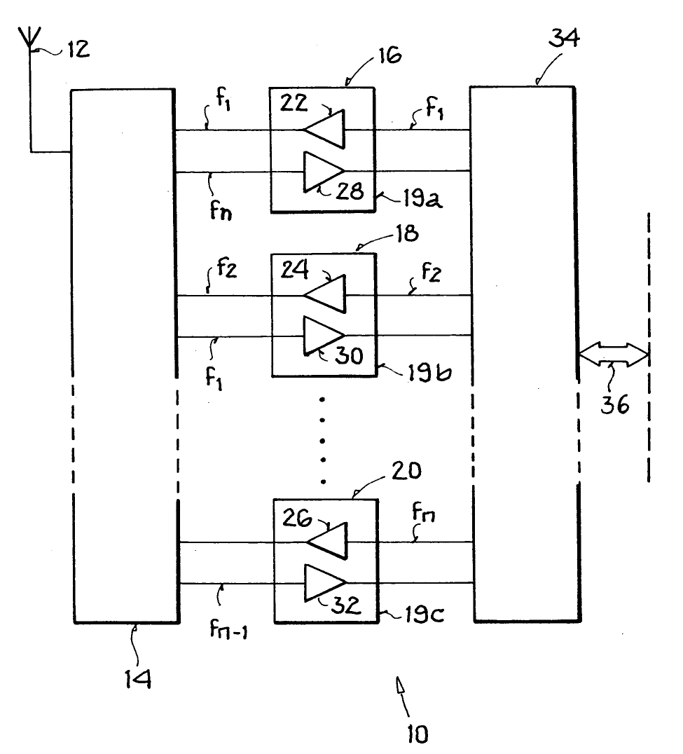

### PRIORITY CLAIM

This application is based on and claims the priority under 35 U.S.C. §119 of German Patent Application 103 36 292.4, filed on Aug. 1, 2003, the entire disclosure of which is incorporated herein by reference.

### FIELD OF THE INVENTION

The invention relates to a transmitting and receiving arrangement having at least two pairs of respectively one transmitting power amplifier and one low noise input amplifier, whereby the respective pairs of amplifiers are respectively allocated to different frequency ranges, and whereby respectively at least one transmitting power amplifier and at least one low noise input amplifier are combined or incorporated in a common structural unit. The invention further relates to a method for operating such a transmitting and receiving arrangement.

### BACKGROUND INFORMATION

It is generally known in the art to combine a transmitting power amplifier with a low noise input amplifier on a common semiconductor substrate. The power amplifier and the low noise amplifier thus together form a common structural unit, which is generally embodied as a monolithic integrated circuit based on any one of different conventional technologies, for example, most often based on silicon technology or gallium-arsenide variations.

The monolithic integration of a low noise input amplifier (also simply called an input amplifier or a low noise amplifier (LNA) herein) and a transmitting power amplifier (also simply called a transmitting amplifier or a power amplifier (PA) herein) on a common semiconductor substrate material achieves various advantages, such as a reduction of the surface area occupied by the components, simplification and economization of the fabrication, among other known advantages.

On the other hand, such monolithic integration of the power amplifier with the low noise amplifier in the same structural unit also causes a significant disadvantage. Particularly, during the transmitting operation, the active transmitting power amplifier generates and dissipates a substantial amount of heat due to its electrical power loss or dissipation, which consequently heats the entire structural unit based on the common semiconductor substrate, including the low noise input amplifier. Since the transmitting power amplifier typically operates with a power much higher or even a substantial multiple of the power of the low noise input amplifier, the input amplifier is actually heated to a significantly higher temperature in the transmitting operation (due to the heat dissipation by the power amplifier) than during pure receiving operation (due to the power dissipation of the low noise input amplifier). In this regard, typical power values are about 300 mW for transmitting operation and about 10 mW for receiving operation.

The above mentioned heating of the low noise input amplifier directly leads to a physically necessitated increase of the noise factor, a drift of the characteristic values or parameters, and an overall deterioration of the reception characteristics of the system. Even with a time-offset or time-shifted operation (time slot method) of the two amplifier components integrated on one chip, i.e. alternating transmission and reception, a substantial heating of the low noise amplifier still arises, due to the thermal store or reservoir behavior of the semiconductor material. This undesirably also applies the heating effect of the transmitting amplifier's power dissipation to the low noise input channel amplifier.

The thermally induced increase of the noise factor F occurs according to the general formula F=K×T×B, wherein F is the noise factor, K is Boltzmann's constant, T is the temperature, and B is the frequency bandwidth of the low noise input amplifier being considered. In order to reduce or avoid the above mentioned undesirable influences of the heating of the low noise amplifier, in special applications such as space travel and radio astronomy, special cooling arrangements are used to cool the low noise input amplifier down to nearly absolute zero temperature. Such special cooling arrangements, however, are quite complicated and costly. Such effort and expense cannot be utilized, already for reasons of cost, in the general field of consumer goods, or especially in connection with mobile telephones, for example GSM (Global System for Mobile Communications) telephones, and wireless data transmission systems such as WLAN (Wireless Local Area Network) applications.

To avoid the above mentioned cross-heating of the low noise input amplifier by the dissipated heat of the power amplifier mounted on the same chip, it is also conventionally known to arrange the low noise input amplifier on a first receiver chip, and to arrange the transmitting power amplifier on a separate second transmitting chip. Due to the spatial separation of the two chips, the receiver chip is not so strongly heated by the operation of the transmitter chip, in comparison to the arrangement with both amplifiers integrated on a single chip. While this achieves the advantage of a reduced heating of the input or receiver chip during operation of the transmitter chip, it necessarily brings about significant disadvantages by requiring two separate chips. Namely, such an arrangement fails to achieve the advantages of a monolithic integration of several amplifiers on a single chip as discussed above.

### SUMMARY OF THE INVENTION

In view of the above, it is an object of the invention to provide a transmitting and receiving arrangement, and a device including such a transmitting and receiving arrangement, with a reduced heating of a low noise input amplifier due to the operation of a transmitting power amplifier. The inventive arrangement shall maintain or achieve the advantages (e.g. the space or volume reduction and the cost reduction) of a monolithic integration of at least one low noise input amplifier and at least one transmitting power amplifier on a single chip or in a single integrated circuit on a common substrate. Another object of the invention is to provide a method of operating such a transmitting and receiving arrangement to reduce the cross-heating of the low noise input amplifier due to the heat dissipation of the transmitting power amplifier. The invention further aims to avoid or overcome the disadvantages of the prior art, and to achieve additional advantages, as apparent from the present specification. The attainment of these objects is, however, not a required limitation of the claimed invention.

The above objects have been achieved according to the invention in a device including a transmitting and receiving arrangement with at least two pairs of respectively one transmitting power amplifier and one low noise input amplifier, wherein the pairs of amplifiers are respectively allocated to different frequency ranges, and wherein respectively at least one transmitting power amplifier and at least one low noise input amplifier are combined or incorporated in a single common structural unit. Especially according to the invention, the low noise input amplifier and the transmitting power amplifier of a given pair allocated to and adapted to operate in a specified frequency range are respectively incorporated in different structural units. For example, the transmitting power amplifier operating in a first frequency range is incorporated in a first structural unit, while the low noise input amplifier operating in this first frequency range is incorporated in a second structural unit separate from the first structural unit. Moreover, the low noise input amplifier incorporated in the first structural unit operates in a frequency range different from the first frequency range.

The above objects have further been achieved according to the invention in a method of operating the transmitting and receiving arrangement in one of the above mentioned frequency ranges, wherein the amplification of received signals in this frequency range is carried out using the low noise input amplifier incorporated in one of the structural units or chips, while the amplification of output signals to be transmitted is carried out using the transmitting power amplifier incorporated in a different one of the structural units or chips. Thereby the input amplifier and the transmitting amplifier being used for this communication are both allocated to the same frequency range and thus form a frequency-based pair of amplifiers, yet are physically located and incorporated in two different and separate chips.

The above features of the invention achieve a physical or spatial separation of the transmitting functions and the receiving functions within a given frequency range, while still also providing a structural incorporation or integration of a transmitting power amplifier and a low noise input amplifier on each individual chip. Due to the physical or spatial separation of the two amplifiers allocated to a particular frequency range or a particular frequency, the input amplifier used for this frequency range will not be heated by the operation of the transmitting amplifier that is active in this frequency range. Namely, the physical or spatial separation, and optionally the arrangement of a thermally insulating material therebetween, consequently provides a thermal isolation between the two amplifiers. Thus, the signal-to-noise ratio of the active input amplifier is not significantly deteriorated (due to heating) by the active transmitting power amplifier. The invention further achieves all the advantages of integrated fabrication of input (or receiving) and output (or transmitting) amplifiers together on a single chip, in an arrangement of several such chips in devices that are adapted to operate selectively in any selected one of plural frequency ranges, such as multi-frequency, multi-band, or multi-mode mobile telephones or data transmitting/receiving devices.

It is especially preferred according to the invention that each structural unit is embodied as a common chip in which at least one of the transmitting power amplifiers and at least one of the low noise input amplifiers are incorporated or integrated. An advantage of this embodiment is that transmitting power amplifiers and low noise input amplifiers can be economically and efficiently realized together in a monolithic integrated circuit from a viewpoint of the fabrication processes and techniques, without causing the above discussed conventional disadvantages arising from an increase of the operating temperature of the input amplifier and thus an increase of the noise factor or a drift of the characteristic operating parameters of the input amplifier.

In principle, the advantage of the monolithic integration becomes ever greater the more that the utilized semiconductor fabrication technologies have characteristics that are suitable for both the transmitting power amplifiers with high operating power and efficiency as well as input amplifiers with low noise factors. The apparent conflict of goals or purposes between a high operating power and efficiency of the power amplifier and a low noise factor of the input amplifier is being ever further reduced in modern transmission or communication systems such as GSM-EDGE (Enhanced Data for GSM Evolution), UMTS or generally CDMA (Code Divisional Multiple Access), because these systems use modulation techniques or processes on the transmission side, which also contain data or transmission informations in the envelope curve of the signal. As a result, however, the demands on the linearity of the transmitting power amplifier are significantly increased.

For that reason, transistors of the transmitting power amplifier are generally no longer operated in the efficiency-optimized C-operating mode (class C), but rather more often in the A-operating mode (class A), which exhibits an improved linearity between the amplifier input signal and the amplifier output signal. The improvement of the linearity, however, comes at the expense of the operating efficiency, which, for physical reasons, is lower in the A-operating mode than in the compressed or optimized B- or C-operating modes of a transistor amplifier.

A further characteristic that is demanded for this type of transmitting power amplifiers, is the lowest possible noise or interference spectrum in the range of adjacent channels, which ultimately can be interpreted as a demand for a low noise factor. Thus, the requirements or demands for a combination technology for integrating transmitting power amplifiers and low noise input amplifiers on a common monolithic chip are identical to each other at least with respect to certain essential aspects. For that reason, both types of amplifiers can be combined in a common integrated circuit in a space-saving manner in an economical and efficient fabrication process.

However, due to the reduced operating efficiency of the transmitting power amplifier with the same output power, the result is an increased thermal dissipation and thus an increased temperature of the chip in which the transmitting power amplifier is incorporated. In principle, this would teach away from such an integration of the amplifiers. Nonetheless, according to the invention, any such increased heat dissipation that might arise is not problematic. Namely, it is exactly the combination achieved by the integration of at least one low noise input amplifier and at least one transmitting power amplifier on a common chip, in connection with the distribution or separation of the transmitting functions and the receiving functions for a given frequency range onto two separate chips, which in sum achieves a reduced noise factor of the low noise input amplifier active at a particular frequency, despite the monolithic integration thereof with a transmitting power amplifier (for a different frequency range) on the same chip.

Moreover, this distribution or separation of the transmitting and receiving functions onto separate chips achieves the advantage of multiple utilization and combination of functional units that would otherwise be redundant in the circuit blocks (e.g. the transceivers) that generate and/or process the signals being transmitted and/or received. This is a significant goal to be strived for, especially for achieving a reduction of costs as well as space saving. An example in which such an application is significant is in wireless local area networks (WLAN) operating at 2.4 and 5.2 GHz.

It is further preferred in a particular embodiment of the invention, that the transmitting power amplifier and the low noise input amplifier are realized as monolithic integrated circuits on a silicon basis or a gallium-arsenide basis. Through these features, the inventive arrangement can be economically fabricated using well-developed fabrication techniques in high volumes or piece counts. As a result, the inventive arrangement can be widely and economically utilized and incorporated into various different devices in various fields.

A further preferred embodiment feature of the invention involves the integration of the amplifiers in structural units embodied as bonded integrated circuits, as a flip-chip in a housing, or in the form of modules on a separate substrate carrier. As is generally known, a bonded chip or bonded integrated circuit is an integrated circuit that is contacted via bond wires. A flip-chip, as conventionally known, refers to a semiconductor wafer with planar diodes or transistors, of which the contacts or connection points are disposed on the backside of the chip. Such flip-chips can be installed in thin film or thick film circuits, and represented a transition stage leading to integrated circuits. In any event, any of these technologies and structural arrangements can be used to provide each structural unit according to the invention. All three of these concrete realizations are well suited to carrying out an economical high volume series production.

It is also preferred that the device in which the transmitting and receiving arrangement according to the invention is incorporated, is a mobile telephone or a portable data communication device. In either case, the device is suitable and adapted to be used or operated in plural frequency ranges. It is especially preferred that the various different frequency ranges are the dual-band or tri-band frequency ranges for mobile telephones, or industrial, scientific or medical ISM frequencies that are usable without a license, or other multi-mode or multi-band applications and/or combinations of mobile telephones with cordless telephones. These applications all offer only a small installation space or volume, while also requiring that transmitting and receiving arrangements adapted for use in plural different frequency bands with good reception and transmission quality must be arranged within the available limited installation volume. Through the invention, these characteristics can be achieved at a cost that is acceptable in the market for such devices.

Another preferred feature of the invention is that the transmitting power amplifier in a particular structural unit is not operated together with the low noise input amplifier provided in this same structural unit, during a given communication or transmission connection. This means that the transmitting amplifier and the input amplifier included in a given structural unit will not both be operated at the same time, and even not during the same communication or transmission connection, e.g. in a time-alternating manner such as in a time slot process. This reliably prevents an undesirable heating of an input amplifier active for a particular frequency by the dissipated heat of a transmitting power amplifier arranged on the same chip as this input amplifier. Since the transmitting power amplifier arranged on the same chip is allocated to a different frequency or different frequency range in comparison to the input amplifier on this chip, and the different frequency ranges are used individually, separately and selectively, one at a time, the cross-heating problem is avoided. Also, the functionality of the application will thereby not be substantially diminished or deteriorated.

It should be understood that the several features of the invention described herein are not limited to the respectively described combinations, but rather can also be provided in different combinations or even individually, still within the scope of the present invention.

### BRIEF DESCRIPTION OF THE DRAWING

In order that the invention may be clearly understood, it will now be described in connection with an example embodiment thereof, with reference to the single accompanying drawing Figure, which schematically illustrates a block diagram of the basic structure of a transmitting and receiving arrangement according to an example embodiment of the invention.

### DETAILED DESCRIPTION OF A PREFERRED EXAMPLE EMBODIMENT AND OF THE BEST MODE OF THE INVENTION

The single drawing Figure shows a transmitting and receiving arrangement 10 that receives and/or transmits signals via an antenna 12. Thus, the transmitting and receiving arrangement 10 is especially or preferably a wireless transmitting and receiving arrangement. The antenna 12 is selectively connected via an antenna circuit selector switch 14 to a group or ensemble of separate individual chips 16, 18 and 20. Each one of these chips 16, 18 and 20 respectively includes at least one transmitting power amplifier 22, 24 or 26 and at least one low noise input amplifier 28, 30 or 32 respectively incorporated in the structural unit embodied by the respective chip. For example, each one of the chips respectively includes at least one of the power amplifiers and at least one of the input amplifiers mounted on a common carrier, or formed on a common substrate, or integrated in the same circuit or overlapping circuits. Note that the three chips 16, 18 and 20 are merely representative of any number n of chips that may be provided, where this number n is at least two according to the present invention.

In the drawing Figure, the individual chips 16, 18 and 20 have merely been schematically and qualitatively illustrated. Thereby, especially the illustrated symmetrical size distribution or proportionality between the low noise input amplifiers 28, 30 and 32 and the transmitting power amplifiers 22, 24 and 26 does not correspond to the actual proportions of these components in a real chip structure. To the contrary, in a real or actual physical chip structure, the transmitting power amplifiers 22, 24 and 26 each occupy a substantially larger surface area than the low noise input amplifiers 28, 30 and 32.

On one side thereof, each chip 16, 18 and 20 is connected by two transmission paths, e.g. two conductors, to the antenna circuit selector switch 14. One conductor respectively connects the output of the power amplifier 22, 24 and 26 to the antenna circuit selector switch 14, and one conductor respectively connects the selector switch 14 to the input of the input amplifier 28, 30 and 32. On the opposite side, namely the side 19a, 19b and 19c oriented away from the antenna circuit selector switch 14 with regard to the circuit connection, each chip 16, 18 and 20 is connected by two transmission paths, e.g. two conductors, to a transmitter/receiver component or transceiver 34. Namely, one conductor connects the transceiver 34 respectively to the input of each power amplifier 22, 24 and 26, while one conductor connects the output of each respective input amplifier 28, 30 and 32 to the transceiver 34.

Further, the transceiver 34 is connected through a suitable interface 36 with any other circuit, component, or system external to the transmitting and receiving arrangement 10, whereby the transceiver 34 outputs the data and/or voice signals received via the antenna 12 and/or receives data and/or voice signals that are to be transmitted from the antenna 12. Thus, schematically, the interface 36 represents the connection to the remainder of any device in which the inventive transmitting and receiving arrangement 10 may be incorporated.

The transmitting and receiving arrangement 10 is adapted to receive and/or transmit data and/or voice signals in any selected one of plural available frequency ranges. Particularly, the arrangement 10 includes the plural transmitting power amplifiers 22, 24 and 26 that are respectively adapted (e.g. configured, dimensioned and tuned) to amplify signals to be transmitted respectively in three different frequency ranges. In other words, each transmitting power amplifier 22, 24 and 26 operates in a different frequency range compared to the other transmitting power amplifiers. Similarly, the plural low noise input amplifiers 28, 30 and 32 are respectively adapted to amplify received input signals in three different frequency ranges. Throughout this application, the respective different frequency ranges may be completely separate non-overlapping ranges, or may be partially overlapping ranges, or may respectively involve different particular tuned frequencies.

The particular circuitry involved in selecting the transmitting power amplifier 22, 24 or 26 and the low noise input amplifier 28, 30 or 32 to be used for transmitting and receiving in a particular communication in a given or selected frequency range is not illustrated in detail, but can be embodied in any conventionally known or future developed manner within the selector switch 14 and/or the transceiver 34. Since such selector arrangements will be understood by persons skilled in this field, and the details thereof are not crucial to the present invention, such details need not be disclosed herein.

A respective pair of amplifiers, respectively including one transmitting power amplifier 22, 24 or 26 and one low noise input amplifier 28, 30 or 32, is respectfully allocated to each frequency range that is to be made available for selection and use in the inventive arrangement 10. For n frequencies or frequency ranges, preferably n chips 16, 18 and 20 are used in the arrangement 10. In that regard, the allocation can be a one-to-one mutually unique or unambiguous allocation, so that exactly one transmitting power amplifier 22, 24 or 26 is respectively allocated to and paired with exactly one input amplifier 28, 30 or 32, and vice versa, respectively for each individual frequency range. Alternatively, there could be a one-to-two or two-to-one allocation among the input amplifiers and the power amplifiers. Thus, the term “pair” of amplifiers as used herein should not be restricted to a closed set of exactly two amplifiers. Instead, the amplifiers can be organized in a “group” for each frequency range, wherein each “group” may include, for example, one transmitting amplifier and one input amplifier, or one transmitting amplifier and two input amplifiers, or two transmitting amplifiers and one input amplifier, etc., as a broader meaning of the term “pair” .

The illustrated embodiment shown in the single drawing Figure involves the one-to-one mutually unique allocation and pairing of input and transmitting amplifiers. Particularly, the first chip 16 is adapted to handle (i.e. amplify) a transmitting frequency f1 and a receiving or input frequency fn, the second chip 18 is adapted to handle a transmitting frequency f2 and an input frequency f1, and the nth chip 20 is adapted to handle a transmitting frequency fn and an input frequency fn-1. It will thus be apparent that each chip 16, 18 or 20 handles respectively different frequencies on the input side and the output side, and correspondingly that the transmitting amplifier 22, 24 or 26 and the input amplifier 28, 30 or 32 paired with each other by being allocated to a given frequency are located not on the same chip, but rather on separate chips 16, 18 and 20.

In the present example, if there are a total of three chips 16, 18 and 20, with three amplifier pairs for handling three different frequencies or frequency ranges, the number or suffix n is taken as 3. Thus, the input side of the first chip 16 handles the frequency f3, the transmitting side of the third chip 20 handles the frequency f3, and the input side of the third chip 20 handles the frequency f2.

In this structure, a first pair of transmitting and input amplifiers is formed by the transmitting power amplifier 22 and the input amplifier 30, which respectively amplify signals at the frequency or in the frequency range f1. A second amplifier pair is formed by the transmitting power amplifier 24 and the input amplifier 32 allocated to the frequency range f2 (i.e. fn-1 when n is 3). A third amplifier pair is formed by the transmitting power amplifier 26 and the input amplifier 28 allocated to the frequency range fn (or f3 in the example in which n is 3).

As mentioned above, in this example embodiment, respectively one transmitting amplifier 22, 24 or 26 is combined and structurally incorporated with respectively one input amplifier 28, 30 or 32 in one respective chip 16, 18 or 20 to form a respective individual structural unit. Nonetheless, the input amplifier (e.g. 30) of each respective frequency-allocated amplifier pair (e.g. the first pair for frequency range f1) is located in a different structural unit (e.g. chip 18) than the structural unit (e.g. chip 16) in which the associated transmitting power amplifier (e.g. amplifier 22) for this frequency is located. Alternatively, each individual transmitting power amplifier can be allocated to more than one input amplifier. The same is true in the reverse also, i.e. vice versa, so that more than one transmitting power amplifier can be allocated to each individual input amplifier. This choice simply depends on how many amplifiers are needed or desired on the transmitting side and/or on the receiving side for each given communication channel or frequency range.

In any event, the allocation of amplifiers on the transmitting side and the receiving side for each given frequency range, according to the invention, is carried out so that the input amplifier or amplifiers allocated to a particular frequency range is or are not arranged on the same chip or chips as the transmitting power amplifier or amplifiers allocated to this frequency range. For example, a two-to-one allocation could involve the input amplifier 28 as well as the transmitting amplifiers 24 and 26 being allocated to a particular frequency range.

It is to be understood that the invention is not limited to a transmitting and receiving arrangement structure having exactly three chips 16, 18 and 20 in connection with one antenna 12 and one transceiver 34. Most basically, it is simply essential that at least one transmitting power amplifier 22, 24, 26 and at least one input amplifier 28, 30, 32 forms an individual structural unit, but the transmitting amplifier and the input amplifier in a single structural unit are not used together in the same communication connection, i.e. for the transmission and reception in the same frequency range. To provide at least two frequency ranges, there must be two or more (n≧2) chips 16, 18, 20. Similarly, there could be more than one antenna 12 and/or more than one transceiver 34, for example separately allocated to separate frequency ranges.

In the following, an example relating to a tri-band mobile telephone will be considered. In such a mobile telephone, the communication is carried out at any time with a selected one of three possible frequencies, depending on the available communication channel, i.e. depending on the available network. In that regard, the frequency is generally fixed by the network that covers the location of the mobile telephone when it carries out the subject communication. At the present time, there are several systems and different networks being used for mobile telephone communications. For example, these different systems include the Digital Cellular System (DCS) with frequencies in a range from 1710 to 1880 MHz, and the Global System for Mobile Communications (GSM) operating in a frequency range from 870 to 960 MHz. Additional networks are being built and made available at the present time, such as the Universal Mobile Telephone Service (UMTS) operating in a frequency range of 1900 to 2170 MHz. In the future, it is expected that still other communication systems or networks operating in various different frequency ranges will become available, and will also be suitable for use in connection with the inventive arrangement.

In the following example, the transmitting and receiving arrangement 10 is operating or communicating in a certain prescribed frequency range fn, to which the transmitting power amplifier 26 on the chip 20 and the input amplifier 28 on the chip 16 are allocated. Thus, the other amplifiers 22, 24, 30 and 32 are not active for this communication in the frequency range fn. Due to the operation of the transmitting power amplifier 26, the chip 20 becomes heated by the dissipated power. This in turn heats the input amplifier 32 which is also arranged on the chip 20, e.g. forming a companion part of a monolithic integrated circuit together with the power amplifier 26 on the chip 20. This would theoretically deteriorate the signal-to-noise ratio of the input amplifier 32. But this is not a problem in the inventive arrangement, because the input amplifier 32 is not being used in this communication carried out in the frequency range fn. To the contrary, the actual reception quality of this communication in the frequency range fn is not deteriorated due to the heating of the chip 20, because the input amplifier 28 allocated to the active frequency range fn is located on a separate chip 16. A thermal isolation is established respectively between the chips 16, 18 and 20, by the physical separation and/or thermal insulation material between the chips.

In other words, an input amplifier 28, 30 or 32 with a low noise factor (low noise amplifier LNA) for a particular network at a particular frequency or frequency range, and a transmitting power amplifier 22, 24 or 26 for a respective different network at a different frequency or frequency range (for example according to the IEEE Standard 802.11 a and b/g or GSM 900 MHz and DCS 1800 and 1900 MHz (tri-band)) are integrated on the common semiconductor substrate material surface of a respective chip 16, 18 or 20. The particular respective transmitting amplifier (28, 30 or 32) and the input amplifier (22, 24 or 26) arranged on a given one of the chips (16, 18 or 20) are not operated together in a given communication or transmitting/receiving connection. This means also, that they are not operated alternately with one another in a time slot method in a common connection or communication. Thereby, the heating of the chip that carries the active input amplifier is substantially reduced, because it is not directly heated by the active transmitting amplifier, which is mounted on a different chip. As a result, the otherwise expected increase of the noise factor and thermally induced shift of the characteristic of the input amplifier is avoided.

This basic principle of the invention is not only applicable to tri-band mobile telephones, but similarly can be used for other multi-band or multi-mode systems that can transmit and receive data, voice signals or the like respectively on any selected one of plural provided frequencies, frequency ranges or channels. In principle, there is no limit to the number of the various different systems and frequency ranges that can be combined. For example, combinations of cellular telephone systems, for example GSM or UMTS, together with cordless telephone systems (for example DECT) are also possible. It should further be noted, that the different systems may also involve different transmission/reception protocols in addition to the different frequency ranges. The actual data transmission protocol of the data or signals being amplified through the inventive amplifier arrangement is not significant and is not a limitation of the invention.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A device including a transmitting and receiving arrangement that comprises:
plural transmitting amplifiers including a first transmitting amplifier adapted to amplify signals to be transmitted in a first frequency range, and a second transmitting amplifier adapted to amplify signals to be transmitted in a second frequency range different from said first frequency range; and
plural input amplifiers including a first input amplifier adapted to amplify signals received in said first frequency range, and a second input amplifier adapted to amplify signals received in said second frequency range;
wherein said transmitting amplifiers and said input amplifiers are arranged in a plurality of structural units, of which each structural unit respectively includes at least one of said transmitting amplifiers and at least one of said input amplifiers incorporated therein; and
wherein said first transmitting amplifier is incorporated in a different one of said structural units than said first input amplifier.

2. The device according to claim 1, wherein said transmitting amplifiers are respective transmitting power amplifiers, and said input amplifiers are respective low nosie input amplifiers.

3. The device according to claim 2, wherein said transmitting power amplifiers have a higher rated operating power than said low noise input amplifiers.

4. The device according to claim 1, wherein said second transmitting amplifier is incorporated in a different one of said structural units than said second input amplifier.

5. The device according to claim 1, wherein said first transmitting amplifier and said second input amplifier are incorporated together in a first one of said structural units.

6. The device according to claim 1, wherein said structural units are all spatially and physically separated from one another.

7. The device according to claim 1, wherein said structural units are all thermally isolated from one another.

8. The device according to claim 1, wherein said structural units are respective discrete chips that each incorporate at least one of said transmitting amplifiers and at least one of said input amplifiers.

9. The device according to claim 1, wherein said structural units are respective silicon or gallium arsenide based monolithic integrated circuits that each incorporate at least one of said transmitting amplifiers and at least one of said input amplifiers.

10. The device according to claim 1, wherein said structural units comprise respective substrate carriers each having at least one of said transmitting amplifiers and at least one of said input amplifiers in the form of respective modules mounted thereon.

11. The device according to claim 1, wherein said structural units comprise respective housings that each have at least one of said transmitting amplifiers and at least one of said input amplifiers in the form of respective flip chips mounted therein.

12. The device according to claim 1, wherein said structural units comprise respective wire-bonded integrated circuits that each incorporate at least one of said transmitting amplifiers and at least one of said input amplifiers.

13. The device according to claim 1, wherein, among said transmitting amplifiers only said first transmitting amplifier is adapted to amplify said signals to be transmitted in said first frequency range, and among said input amplifiers only said first input amplifier is adapted to amplify said signals received in said first frequency range.

14. The device according to claim 1, wherein, among said transmitting amplifiers only said first transmitting amplifier is adapted to amplify said signals to be transmitted in said first frequency range, and said input amplifiers include another of said input amplifiers adapted to amplify said signals received in said first frequency range.

15. The device according to claim 14, wherein each one of said structural units incorporates no more than one of said amplifiers adapted to amplify signals in any one frequency range.

16. The device according to claim 1, wherein, among said input amplifiers only said first input amplifier is adapted to amplify said signals received in said first frequency range, and said transmitting amplifiers include another of said transmitting amplifiers adapted to amplify said signals to be transmitted in said first frequency range.

17. The device according to claim 16, wherein each one of said structural units incorporates no more than one of said amplifiers adapted to amplify signals in any one frequency range.

18. The device according to claim 1, further comprising an amplifier selector that is connected to all of said transmitting amplifiers and all of said input amplifiers, and that is adapted to select and activate said first transmitting amplifier and said first input amplifier for a communication involving transmitting and receiving signals in said first frequency range.

19. The device according to claim 18, wherein said amplifier selector is adapted to not select and not activate a respective one of said input amplifiers incorporated in a respective one of said structural units together with said first transmitting amplifier during said communication for which said first transmitting amplifier is selected and activated.

20. The device according to claim 1, wherein said device is a wireless device that further comprises at least one transmitting and receiving antenna connected selectively to said transmitting amplifiers and said input amplifiers.

21. The device according to claim 1, wherein said device is a mobile telephone or a portable data communication device.

22. The device according to claim 1, wherein said first frequency range and said second frequency range are respective different frequency ranges selected from the group consisting of dual-band mobile telephone frequency ranges, tri-band mobile telephone frequency ranges, and ISM frequency ranges provided for license-free industrial, scientific or medical uses.

23. The device according to claim 1, wherein said first frequency range is a mobile telephone frequency range and said second frequency range is a cordless telephone frequency range.

24. A device including a transmitting and receiving arrangement that comprises:
plural transmitting amplifiers that are respectively adapted to amplify signals to be transmitted in respective different frequency ranges; and
plural input amplifiers that are respectively adapted to amplify signals received in said respective different frequency ranges;
wherein said transmitting amplifiers and said input amplifiers are arranged in a plurality of structural units, of which each structural unit respectively includes at least one of said transmitting amplifiers and at least one of said input amplifiers incorporated therein; and
wherein all of said amplifiers incorporated in a respective one of said structural units, compared to each other, are adapted to amplify said signals in different ones of said frequency ranges, and no more than one of said amplifiers incorporated in said respective one of said structural units is activated for a given communication involving transmitting and receiving said signals in a given one of said frequency ranges.

25. A method of operating a transmitting and receiving arrangement including plural chips, wherein each one of said chips includes a respective integrated circuit incorporating at least one transmitting power amplifier and at least one low noise input amplifier that are adapted to amplify signals in different frequency ranges in comparison to one another, said method comprising:
a) amplifying a first signal in a first frequency range in a first one of said transmitting power amplifiers incorporated in a first one of said chips to provide an amplified first signal in said first frequency range;
b) transmitting said amplified first signal in said first frequency range;
C) receiving a second signal in said first frequency range; and
d) amplifying said second signal in said first frequency range in a first one of said low noise input amplifiers incorporated in one of said chips other than said first one of said chips to provide an amplified second signal in said first frequency range.

26. The method according to claim 25, further comprising switching from said first frequency range to a second frequency range different from said first frequency range and then carrying out the steps:
e) amplifying a third signal in said second frequency range in a second one of said transmitting power amplifiers incorporated in a second one of said chips to provide an amplified third signal in said second frequency range;
f) transmitting said amplified third signal in said second frequency range;
g) receiving a fourth signal in said second frequency range; and
h) amplifying said fourth signal in said second frequency range in a second one of said low noise input amplifiers incorporated in one of said chips other than said second one of said chips to provide an amplified fourth signal in said second frequency range.
